(19) United States
(12) Patent Application Publication
(10) Pub. No.: US 2012/0129122 A1
(43) Pub. Date: May 24, 2012

(54) Device for Orthodontic Arch and Brackets

(75) Inventors: Luis Carriere Lluch, Barcelona (ES); José Carriere Pons, Barcelona (ES)

(73) Assignee: ORTHODONTIC RESEARCH AND DEVELOPMENT, S.L., Barcelona (ES)

(21) Appl. No.: 13/387,335

(22) PCT Filed: Jul. 22, 2010
(86) PCT No.: PCT/ES10/00319

§ 371 Date: Jan. 26, 2012

(30) Foreign Application Priority Data
Jul. 27, 2009 (ES) P200930519

(51) Int. Cl. A61C 7/28

(52) U.S. Cl. 433/17

(57) ABSTRACT

Orthodontic device comprising an orthodontic arch or a wire and a set of brackets which have conduits through which said orthodontic arch passes characterized in that either of the following: a surface of the conduit of at least one bracket that is aimed to come into contact with the wire, or a region of the wire in contact with at least one bracket, has a textured surface with protruding regions and sunken regions for reducing the contact surface between the bracket and the orthodontic arch, the surface of the wire or of the bracket aimed to come into contact with the textured surface being of smooth nature.

The present invention relates to an orthodontic device especially suitable for orthodontic and/or maxillofacial orthopedic applications.

In particular, the present invention refers to orthodontic devices comprising a kit constituted by a wire or orthodontic arch and a series of brackets joined to teeth, the brackets having conduits through which the orthodontic arch passes.

One of the objectives normally desired for this type of devices is for the friction between the brackets and the orthodontic arch to be as small as possible. According to the known technique in the technical field, reduction of the friction and improvement of the sliding must be achieved by means of polishing and/or finishes of the contact surfaces that cause them to have a maximum smoothness, with the goal of reducing the coefficient of friction.

Nevertheless, the levels of sliding obtained by means of the known technique are still improvable. Moreover, the known technique requires additional elements if regulation of the sliding is desired. This happens, for example, if a goal is to obtain regions with greater sliding than others or to stimulate the sliding uniquely in one of the two senses of the axial direction of the arch.

A goal of the present invention is to disclose a solution to the problems previously mentioned, disclosing new orthodontic devices, which have a level of friction between their components that is smaller than the level of friction of the devices known nowadays, the level of friction being furthermore adjustable during manufacture, and, if wanted, selective, since a preferential sense of sliding may be selected.

More particularly, the present invention discloses both of the following: an orthodontic device comprising a kit constituted by an orthodontic arch or a wire and a series of brackets, an orthodontic arch, and a type of bracket that are especially suitable as components of the orthodontic device likewise object of the present invention.

The orthodontic device object of the present invention comprises an orthodontic arch constituted by a wire and a set of brackets which have conduits through which said orthodontic arch passes. In the orthodontic device object of the present invention, either the surface of the conduit of at least one bracket which is aimed to come into contact with the wire, or a region of the wire in contact with at least one bracket, has a textured surface with protruding regions and sunken regions for reducing the contact surface between the bracket and the orthodontic arch.

The present invention may be applied to self-ligating brackets of any kind, preferably to passive self-ligating brackets.

The contact of the textured surface with the smooth surface is produced in the higher points of the prominences, in such a way that the contact surface and, thus, the friction is reduced. It is worth mentioning that, with the objective of reducing the friction, the surface in contact with the textured surface must be smooth. If said surface was textured, an extraordinarily high level of friction between surfaces would be obtained.

Equally, with the objective of reducing the contact surface between the surfaces, the upper surface of the protruding regions will preferably be convex or concave.

The present invention also provides preferential shapes of the textured surface of the device object of the present invention for ensuring a lower friction.

For example, preferably the projection of the highest points of the textured surface, said projections being in the axial direction of sliding of the arch, does not cover all regions of the perimeter of the textured surface. This ensures a minimized contact surface in case of movements in the tangential or perimeter direction of the section of the arch.

Analogously, it is also preferential that the projection of the high points of the textured surface in the perimeter direction leaves some regions of the textured surface uncovered. This ensures the existence of points without contact in each possible axial path between the surface of the bracket and the wire.

Preferred embodiments of the textured surface of the device object of the present invention follow a regular pattern, the protruding regions having prismatic, parallelepipedic, polyhedric, pyramidal, semi-ovoid or semi-spheroid general shape. In the cases of prismatic, parallelepipedic, polyhedric, and/or pyramidal shapes, the edges will preferably be rounded.

Likewise, the present invention also provides textured surfaces that promote the sliding in one direction, whereas the sliding in the opposite direction is made difficult. For achieving that, the protruding regions form an acute angle with the sunken region in a mesial or proximal end, and a right or acute angle in the opposite end. More preferably, at least some protruding regions partially cover adjoining protruding regions.

The orthodontic device object of the present invention may be constituted from devices of known type in which either one or various brackets with the textured surface object of the present invention, or an orthodontic arch whose wire has the textured surface object of the present invention, are used.

More particularly, the present invention also comprises a bracket, which comprises a conduit for passage of a wire of orthodontic arch, the surface of said conduit comprising a textured surface with protruding regions and sunken regions for reduction of the contact surface between bracket and orthodontic arch.

Preferentially, the protruding regions have a convex or concave outer surface.

More preferably, the projection of the highest points of the protruding regions of the textured surface in the axial direction of sliding of the arch, leaves some regions of the perimeter of the textured surface uncovered. Likewise preferably, the projection of the high points of the textured surface in the perimeter direction does not cover some regions.

Also preferably, the protruding regions of the textured surface follow a regular pattern.

The protruding regions of the textured surface of the bracket will preferably have prismatic, parallelepipedic, polyhedric, pyramidal, semi-ovoid or semi-spheroid general shape.

The protruding regions of the textured surface of the bracket may likewise form an acute angle with the sunken region around them in a mesial or proximal end and a right or acute angle in the opposite end. In this case, even more preferentially, at least some protruding regions will partially cover adjoining protruding regions.

In the same way, the present invention further comprises an orthodontic arch that has a textured surface that permits the orthodontic arch to be comprised in orthodontic devices object of the present invention.

The orthodontic arch of the present invention will preferably be constituted by a wire of single solid section. The wire may have a textured surface along its entire outer surface or only on a part of its outer surface, and this textured surface may have regions of textures unconnected with each other, which may match with real or hypothetic positions of brackets.

In any case, the wire that constitutes the orthodontic arch will have at least one region aimed to come into contact with a bracket which will have, in turn, the textured surface with sunken protruding regions to reduce the contact surface between brackets and orthodontic arch.

Preferentially, the protruding regions will have a concave or convex upper surface.

Preferably, the projection of the highest points of the protruding regions of the textured surface in the axial direction of sliding of the arch, does not cover regions of the perimeter of the textured surface. Likewise in a preferred way, the projection of the high points of the textured surface in the perimeter direction does not cover some regions.

The protruding regions of the textured surface will follow a regular pattern. Likewise, they may have prismatic, parallelepipedic, polyhedric, pyramidal, semi-ovoid or semi-spheroid general shape.

More preferably, the protruding regions and/or the sunken regions have a shape of a curved eminence with a polygonal, circular, ovoid or elliptic base.

In embodiments that aim at having different friction coefficients in opposite directions, the protruding regions form an acute angle with the sunken region in a mesial or proximal end, and a right or acute angle in the opposite end. More preferentially, in this case, the protruding regions will partially cover adjoining protruding regions.

For a better understanding of the invention, figures of an embodiment of the present invention are attached as an explanatory but non-limiting example.

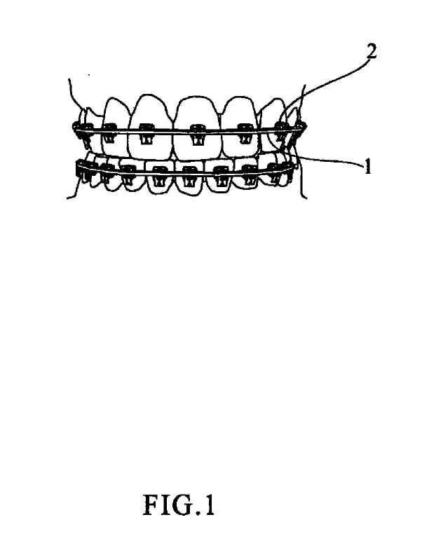

FIG. 1 is a perspective view of an orthodontic device that comprises an orthodontic arch constituted by a wire and a set of brackets. In this case, the device is already implanted in a denture, the brackets being joined to the teeth.

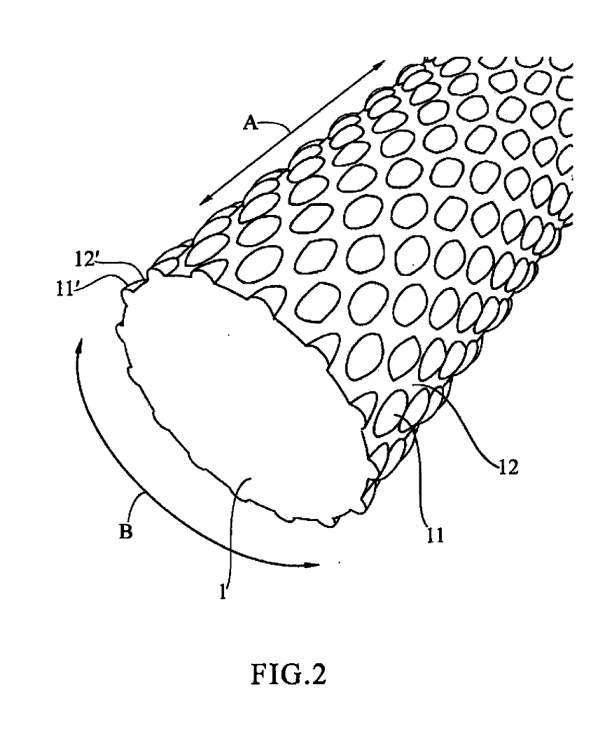

FIG. 2 shows a perspective view of a section of a wire for a device object of the present invention.

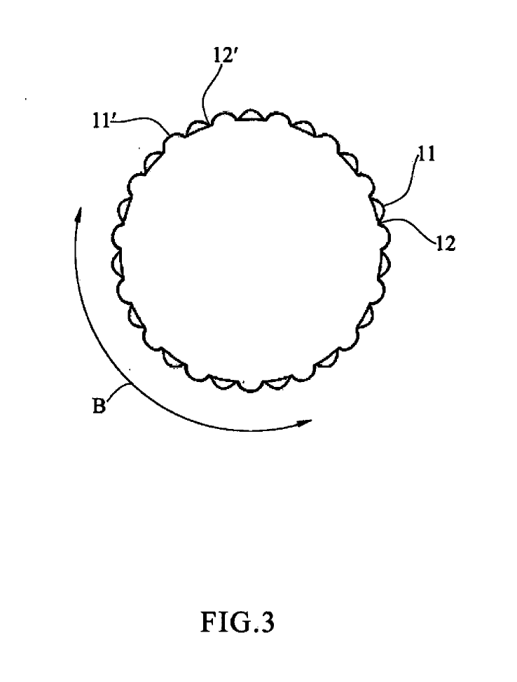

FIG. 3 is a cross-sectional view of the wire of the FIG. 2.

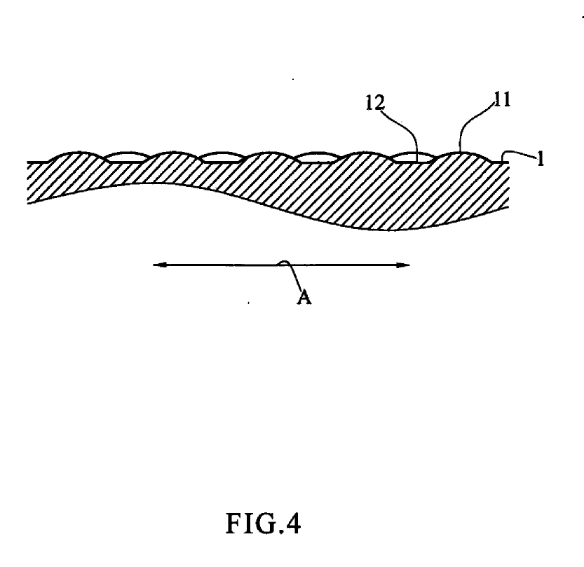

FIG. 4 shows a section in which the projection in the perimeter direction of the protruding regions of the wire of the FIG. 2 can be seen.

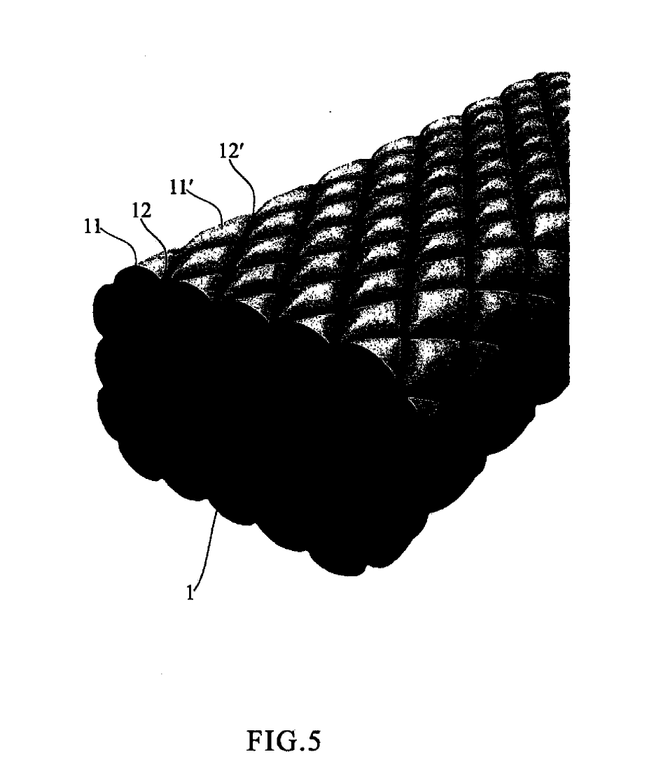

FIG. 5 shows a perspective view of another wire section for a device object of the present invention.

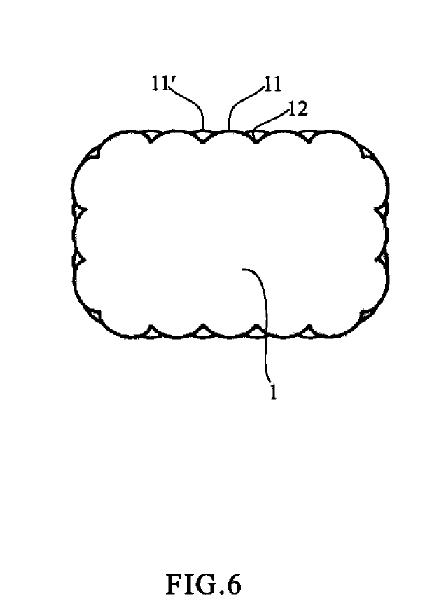

FIG. 6 is a cross-section view of the wire of the FIG. 5.

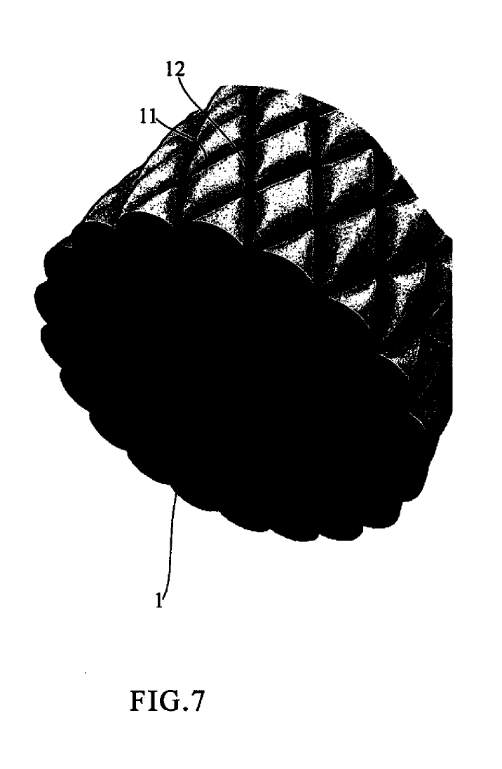

FIG. 7 shows a perspective view of another wire section for a device object of the present invention.

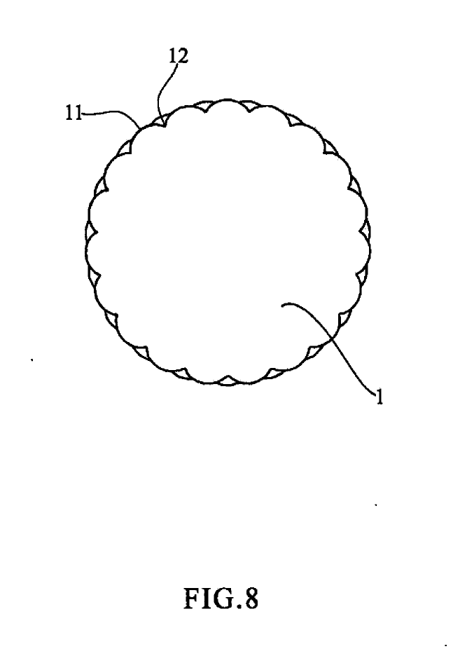

FIG. 8 is a cross-sectional view of the wire of the FIG. 7.

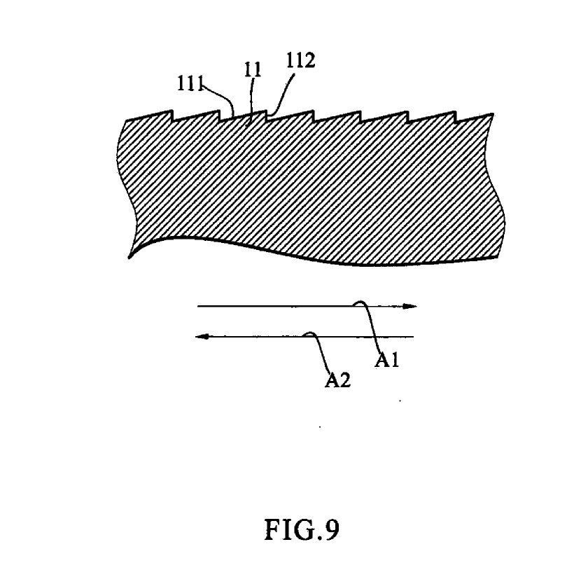

FIG. 9 shows another section in which the projection in the perimeter direction of the protruding regions of another textured surface according to the present invention can be seen.

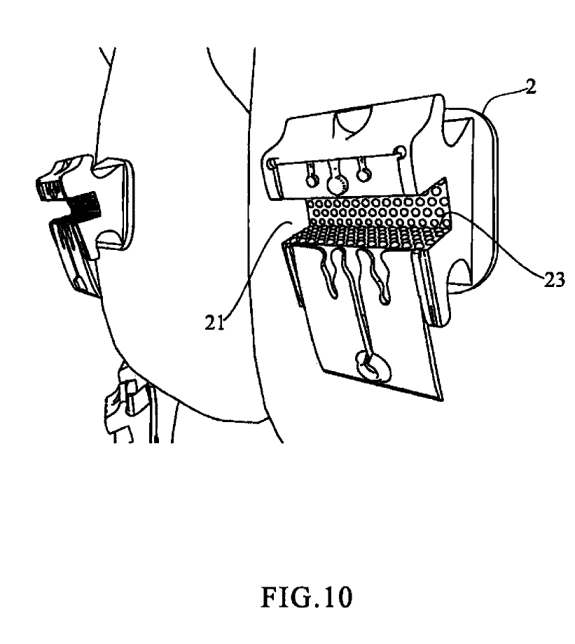

FIG. 10 shows a bracket according to the present invention.

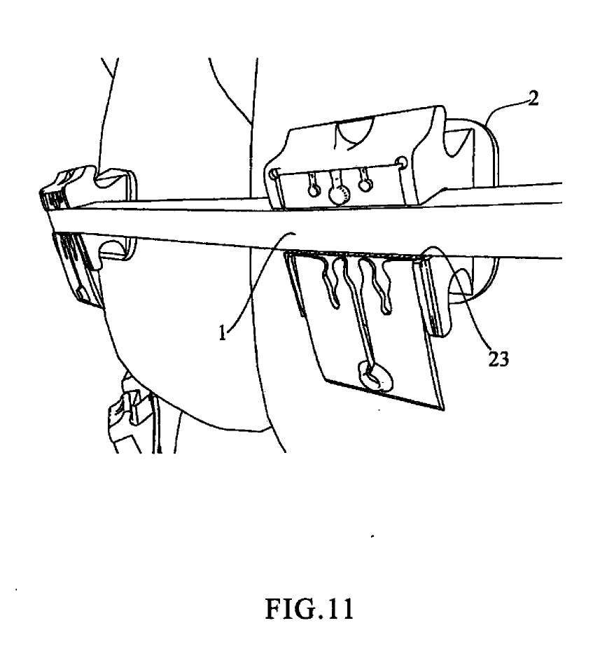

FIG. 11 shows the bracket of the FIG. 10 in which a wire of orthodontic arch has been inserted.

FIG. 1 shows an orthodontic device on which the orthodontic device object of the present invention is based, said orthodontic device comprising an orthodontic arch -1- that may be constituted by a solid metallic wire and some brackets -2-. The brackets -2- have conduits -21- through which the wire of orthodontic arch -1- may pass.

According to the present invention, in the device object of the present invention, the surfaces of contact between arch and bracket belonging either to the wire or to the bracket have a textured surface whereas the other surface is smooth. That is to say, the textured surface may be either on the surface of the conduit or conduits -21- of at least one bracket -2- or on at least a part of the surface of the wire of the orthodontic arch -1-.

As it can be seen in the figures, the textured surface has protruding regions -11-, -11′- and sunken regions -12-, -12′- whose objective is to reduce the contact surface between bracket -2- and wire -1-. For even further reducing the contact surface, it is preferred that the protruding regions have a convex shape. They may also be concave for achieving the same objective. Regular geometric shapes can be selected for the protruding regions -11-, -11′-, even though they will preferably have rounded edges for preventing indentation of the protruding regions on the smooth surfaces with which they come into contact.

The arrangement of the protruding and sunken regions may be both homogeneous and irregular.

Likewise with the objective of reducing the friction between surfaces, in the shown example, the protruding regions are arranged (for example, in offset rows) in such a way that the projection of the highest points of the protruding regions -11-, -11′- of the textured surface in the axial direction -A- of sliding of the arch, do not cover all regions of the perimeter -B- of the textured surface. Likewise the projection in the perimeter direction -B- of the high points of the textured surface does not cover some regions as shown in the FIGS. 2 to 8. This can be achieved with independence of that the textured surface is on the wire -1- or in the conduits of the bracket.

In FIG. 9 a textured surface that facilitates the sliding in one sense of the axial direction has been schematically shown, but it makes the sliding difficult in the opposite sense -A2-. To this end, the protruding regions -11- have mesial or proximal faces -111- and distal faces -112- which form an acute angle with the sunken regions. It is also possible that one of the two faces -112- forms a right angle. Likewise, in this configuration, it is preferred that a protruding region -11- partially covers the adjoining protruding region.

Even though in the FIGS. 2 to 9 the textured surface has been arranged on the wire -11- that constitutes the orthodontic arch, the textured surface -23- may be arranged on the conduits -21- for the orthodontic arch -1-. In this case, the orthodontic arch -1- will be of smooth nature, as shown in the FIG. 11.

In the case of the textured surface being arranged on the wire, it can be only arranged either on delimited and unconnected regions of the wire, or on the entire surface. Likewise, the cross-section of the wire -1- can be any desired one (cylindrical, rectangular, etc.).

Even though the invention has been described with respect to examples of preferred embodiments, they should not be considered limitative of the invention, which will be defined by the broadest interpretation of the following claims.

1. An orthodontic device comprising an orthodontic arch wire and a set of brackets which have conduits through which said orthodontic arch passes wherein a surface of the conduit of at least one bracket that is adapted to come in contact with the wire constitutes a first contact surface, and a region of the wire adapted to come in contact with a bracket constitutes a second contact surface, wherein either the first or the second contact surface has a textured surface with a plurality of protrusions, recesses being formed in between the protrusions and the other contact surface is smooth.

2. An orthodontic device according to claim 1, wherein the protrusions have a convex upper surface.

3. An orthodontic device according to claim 1, wherein the protrusions have a concave upper surface.

4. An orthodontic device according to claim 1, wherein an axial direction is defined by the direction of sliding of the arch, and wherein the protrusions are spaced apart from each other along the axial direction.

5. An orthodontic device according to claim 1, wherein an axial direction is defined by the direction of sliding of the arch, and wherein the protrusions are provided in staggered axial rows.

6. An orthodontic device according to claim 1, wherein the protrusions of the textured surface follow a regular pattern.

7. An orthodontic device according to claim 1, wherein the protrusions have a prismatic, parallelepipedic, polyhedric, pyramidal, semi-ovoid or semi-spheroid general shape.

8. An orthodontic device according to claim 1, wherein the protrusions are curved bulges with a polygonal, circular, ovoid or elliptic base.

9. An orthodontic device according to claim 1, wherein the protrusions at a first edge of the protrusion form an acute angle with the neighbouring recess, and form a right or acute angle at the opposite edge.

10. An orthodontic device according to claim 9, wherein at least some of the protrusions partially cover adjoining protrusions.

11. (canceled)

12. A bracket comprising a conduit for the passage of a wire of an orthodontic arch, wherein the surface of said conduit comprises a textured surface with protrusions and recesses for reduction of the contact surface between bracket and orthodontic arch.

13. A bracket according to claim 12, wherein the protrusions have a convex upper surface.

14. A bracket according to claim 12, wherein the protrusions have a concave upper surface.

15. A bracket according to claim 12, wherein the protrusions are arranged in staggered axial rows.

16. (canceled)

17. A bracket according to claim 12, wherein the protrusions of the textured surface follow a regular pattern.

18. A bracket according to claim 12, wherein the protrusions have a prismatic, parallelepipedic, polyhedric, pyramidal, semi-ovoid or semi-spheroid general shape.

19. A bracket according to claim 12, wherein the protrusions are curved bulges with a polygonal, circular, ovoid or elliptic base.

20. A bracket according to claim 12, wherein the protrusions form an acute angle with the recesses in a mesial or proximal end, and a right or acute angle in the opposite end.

21. A bracket according to claim 20, wherein at least some protrusions partially cover adjoining protrusions.

22. A bracket according to claim 12, wherein the bracket is a passive self-ligating bracket.

23. An orthodontic archwire wherein at least one region of the wire aimed that in use comes into contact with a bracket has a textured surface with a plurality of protrusions such that its contact surface between the bracket and the orthodontic arch is reduced.

24. An orthodontic archwire according to claim 23, wherein the protrusions have a convex upper surface.

25. An orthodontic archwire according to claim 23, wherein the protrusions have a concave upper surface.

26. An orthodontic archwire according to claim 23, wherein an axial direction is defined as a direction of sliding of the arch, and wherein the protrusions are spaced apart from each other in said axial direction.

27. An orthodontic archwire according to claim 26, wherein the protrusions are spaced apart from each other in a perimetral direction.

28. An orthodontic archwire according to claim 23, wherein the protrusions of the textured surface follow a regular pattern.

29. An orthodontic archwire according to claim 23, wherein the protrusions have a prismatic, parallelepipedic, polyhedric, pyramidal, semi-ovoid or semi-spheroid general shape.

30. An orthodontic archwire according to claim 23, wherein the protrusions are curved bulges with a polygonal, circular, ovoid or elliptic base.

31. An orthodontic archwire according to claim 23, wherein the protrusions having a triangular cross-section in a first direction, form an acute angle with a neighbouring region at one end of the protrusion, and a right or acute angle at the opposite end.

32. An orthodontic archwire according to claim 31, wherein at least some protrusions partially cover adjoining protrusions.

33. An orthodontic archwire according to claim 23, which comprises textured regions that are spaced apart from each other.

34. (canceled)

35. A bracket comprising a conduit for the passage of a wire of an orthodontic arch, wherein the surface of said conduit comprises a textured surface with recesses for a reduction of the contact surface between bracket and orthodontic arch.

36. An orthodontic archwire, wherein at least one region of the wire that in use comes into contact with a bracket has a textured surface with a plurality of recesses such that its contact surface between the bracket and the orthodontic arch is reduced.
